(19) United States
(12) Patent Application Publication
(10) Pub. No.: US 2024/0322192 A1
(43) Pub. Date: Sep. 26, 2024

(54) COMPONENT FOR AN ELECTROCHEMICAL CELL, REDOX FLOW CELL, AND ELECTROLYSER

(71) Applicant: Schaeffler Technologies AG & Co. KG, Herzogenaurach (DE)

(72) Inventors: Ladislaus DOBRENIZKI, Höchstadt (DE); Bertram HAAG, Uehlfeld (DE); Jan-Peter Viktor SCHINZEL, Fürth (DE); Jeevanthi VIVEKANANTHAN, Krefeld (DE); Jan Martin STUMPF, Erlangen (DE); Moritz WEGENER, Erlangen (DE)

(73) Assignee: Schaeffler Technologies AG & Co. KG, Herzogenaurach (DE)

(21) Appl. No.: 18/573,555

(22) PCT Filed: Mar. 19, 2022
(86) PCT No.: PCT/DE2022/100379

§ 371 Date: Dec. 22, 2023

(30) Foreign Application Priority Data
Jun. 30, 2021 (DE) 102021116770.1
May 17, 2022 (DE) 102022112319.7

(51) Int. Cl. H01M 8/0228; C25B 1/04; C25B 13/05; H01M 8/0206; H01M 8/10; H01M 8/18

(52) U.S. Cl. CPC H01M 8/0228; C25B 1/04; C25B 13/05; H01M 8/0206; H01M 8/188; H01M 2008/1095

(57) ABSTRACT

A component of an electrochemical cell, the component including a metal substrate and a layer system that is at least partially electroplated onto the metal substrate; the layer system optionally includes a first layer disposed on the metal substrate, and includes at least one second layer that is disposed on the metal substrate or, if applicable, on the first layer, the optional first layer being made of copper or nickel, and the at least one second layer being made of an alloy including at least two of the elements tin, copper, nickel, silver, zinc, bismuth, antimony, cobalt, manganese, tungsten, nonmetal particles having electrically conductive particles being incorporated into the alloy. The component forms in particular an electrode for a redox flow cell or a flow field plate for a fuel cell or an electrolyser.

### CROSS-REFERENCE TO RELATED APPLICATIONS

This application is the U.S. 371 National Phase of PCT Appln. No. PCT/DE2022/100379, filed May 19, 2022, which claims priority from German Patent Application No. 10 2021 116 770.1, filed Jun. 30, 2021 and German Patent Application No. 10 2022 112 319.7, filed May 17, 2022, the entire disclosures of which are incorporated by reference herein.

### TECHNICAL FIELD

The disclosure relates to a component for an electrochemical cell comprising a metal substrate and a layer system that is at least partially electroplated onto the metal substrate, wherein the layer system comprises a first layer disposed on the metal substrate and a second layer disposed on the first layer.

The disclosure further relates to electrochemical cells in the form of redox flow cells, electrolyzers, and fuel cells.

### BACKGROUND

Hydrogen represents an important raw material for key technologies with a view to future energy storage and energy conversion. Water electrolysis is based on the separation of water into the components hydrogen (H₂) and oxygen (O₂). A hydrogen-powered fuel cell generates electrical energy from the hydrogen. A reduction in the hydrogen production costs by electrolyzers comprising a polymer electrolyte membrane (PEM-EL) and a reduction in the production costs of the components of a fuel cell comprising a polymer electrolyte membrane (PEM-FC) represent a basic requirement for the future efficient use of these systems. The main components of a PEM electrolyzer stack/PEM fuel cell stack are the flow field plates (FFP), the current collectors or fluid diffusion layers and the membrane electrode assembly (MEA). The materials and production of the flow field plates contribute a not insignificant proportion to the manufacturing costs of the respective stacks. The essential requirements for the components, such as the flow field plates and fluid diffusion layers, are high corrosion resistance combined with low substrate and interface resistances in both fields of application.

Titanium and stainless steel plates are the state of the art in electrolysis. While the field of application of stainless steel plates on the anode side is limited to pH ranges around 7 due to high oxidation potentials, titanium plates can be used over a wide pH range from 1 to 7. Titanium proves to be disadvantageous on the cathode side, as it has a tendency to hydrogen embrittlement. Furthermore, the operation of electrolyzer stacks with titanium plates shows an increase in ohmic losses due to surface passivation. Against this background, the use of niobium, platinum, or gold coatings on titanium plates is known. A comprehensive use of stainless steel to form a flow field plate requires the use of an electrochemically stable, conductive and, in particular, dense, impenetrable coating. In particular, a leak-tightness against aqueous electrolytes should be achieved.

In the case of PEM-FC, the existing potential windows are more moderate and the pH range is largely limited to 3. However, local operating conditions can occur in the cell that can lead to potentials >1.4 V SHE (standard hydrogen electrode). This requires the use of layers containing precious metals such as Ir, Ru, or Au, the material costs of which, despite layer thicknesses in the nm range, are above the target cost range for flow field plates of $3/kW (generally recognized target of the US Department of Energy for 2025).

EP 3 336 942 A1 describes a metal sheet for forming a separator for a polymer electrolyte fuel cell. The metallic substrate has a film coating the surface of the substrate, with an island-shaped intermediate layer between the substrate and the film. The intermediate layer comprises at least one element from the group consisting of nickel, copper, silver, gold, or is formed from a NiP alloy. As an exemplary embodiment, a substrate made of stainless steel with an island-shaped intermediate layer made of NiP and an electrochemically applied film made of TiN-dispersed Ni₃Sn₂ is described.

JP 2010-272 429 A discloses a separator for a fuel cell with a substrate made of copper or a copper alloy coated with at least one wet-chemically formed first layer made of tin or a tin alloy. The first layer can contain a conductive filler, particularly in the form of carbon.

The US 2019/0 148 741 A1 describes an electrochemical device such as a fuel cell, a battery, an electrolyzer, a redox flow battery, comprising a coated component that has a substrate made of preferably a metal, such as copper, iron, titanium, aluminum, nickel, or stainless steel. The substrate has a coating of tin or a tin alloy, such as a tin-nickel alloy, a tin-antimony alloy, a tin-nickel-antimony alloy, and an electrically conductive coating comprising a carbon-based material and an azole-containing corrosion inhibitor. Flow battery systems as storage systems also enable a sustainable energy supply for stationary and mobile applications using renewable energies. To achieve high efficiencies and power densities, the aim is to have battery stacks that are as compact as possible. However, high power densities pose major challenges regarding the individual components of a battery stack. A new approach here is a metallic electrode with structured geometry to ensure a homogeneous distribution of an electrolyte in the active region, and at the same time to enable small distances to the membrane. On the other hand, metallic electrodes require appropriate surface properties that meet the high requirements for electrochemical stability, low interface resistance and catalytic activity.

In a redox flow cell, composite plates comprising plastic and graphite (thickness ˜0.5-0.6 mm) with an active soot coating (thickness ˜0.1-0.3 mm) applied on both sides are often used as electrodes, which are applied dry-pressed or wet-chemically. This results in a total plate thickness of the electrode of ˜0.7-1.2 mm. With metallic plates, thicknesses of <0.5 mm can be achieved over large areas. It can also be assumed that the processability of large-area metallic plates is more favorable compared to injection-molded plastic frames with graphite-based electrodes.

Another cell configuration, such as the all-vanadium redox flow cell, consists of two flow field plates in the form of two electrodes, usually with graphite felt to increase the active surface, and a membrane. The electrolyte consists of vanadium dissolved in sulfuric acid (pH<1). The flow field plates (thickness about 0.5-0.6 mm) are usually used as planar plates made of pure graphite or a graphite-polymer composite. Flow field plates made of polypropylene filled with graphite or carbon nanotubes are characterized by high corrosion resistance and high overvoltages for the hydrogen formation reaction (HFR).

Compared to flow field plates made of graphite composites, metallic flow field plates are characterized by their higher electrical conductivity and higher mechanical stability or strength, which in cell configurations comprising graphite felt lead to higher performance and efficiency due to low ohmic losses.

In the PEM-EL, PEM-FC, and redox flow cell applications, electrically conductive, dense coatings are required. These take on the function of a barrier layer and can be increased in terms of their performance, in particular catalytic effectiveness, by additional layers applied thereto. The requirements can be summarized as follows:

Electrochemical stability:
pH range: 1-14
Potential range: −1 V NHE to +3 V NHE (short time: −2 V NHE to +3 V NHE)
Operational life: >10000 h
Interface resistance: <10 mOhm·cm² (at 100 N/cm² contact pressure)

### SUMMARY

It is the object of the disclosure to provide a component for an electrochemical cell which meets these requirements for electrochemical stability and low interface resistance. A further object of the disclosure is to provide an electrochemical cell in the form of a redox flow cell, an electrolyzer or a fuel cell with such a component.

The object is attained for the component of an electrochemical cell, comprising a metal substrate and a layer system that is at least partially electroplated onto the metal substrate, wherein the layer system optionally has a first layer disposed on the metal substrate and at least one second layer disposed on the metal substrate or, if present, on the first layer, with the optional first layer being formed from copper or nickel and the at least one second layer from an alloy comprising at least two of the elements tin, copper, nickel, silver, zinc, bismuth, antimony, cobalt, manganese, tungsten, wherein non-metallic particles comprise electrically conductive particles embedded in the alloy.

The electrically conductive particles have an electrical conductivity in a temperature range of 20 to 25° C. in a range of 0.25 mΩ·cm² to 10 mΩ·cm².

Such components have excellent electrochemical stability, as required in electrochemical cells. Due to the low interface resistance, such components are particularly suitable for the formation of electrodes of a redox flow cell, flow field plates for fuel cells and electrolyzers and fluid diffusion layers of electrolyzers. The presence of non-metallic particles, which are embedded in the alloy in the second layer, improves the mechanical stability of the layer system and, depending on the material of the particles used, also enables a further reduction in the interface resistance and thus an increase in the efficiency of the electrochemical cell.

The materials tin and nickel have proven to be thermodynamically stable over a wide pH range due to the formation of oxides. An alloy made from a tin-nickel alloy comprising a nickel content in the range from 20 to 30 wt % is therefore particularly preferred. Such a low nickel content is of great advantage in view of the resulting reduced nickel diffusion into the membrane of an electrochemical cell, since this leads to a minimization or prevention of nickel poisoning of the membrane and thus effectively prevents a drop in cell performance. As a result, second layers made of such a tin-nickel alloy with electrically conductive particles dispersed therein, in particular made of carbon and/or graphite and/or carbon nanotubes and/or carbon fibers and/or soot and/or graphene and/or graphene oxide, have proven to be more stable in the long term as comparison layers of gold.

The alloy is alternatively made of a copper-tin alloy or a tin-silver alloy or a tin-zinc alloy or a tin-bismuth alloy or a tin-antimony alloy or a tin-cobalt alloy or a nickel-tungsten alloy or a tin-manganese alloy.

SnCu in particular has proven to be a powerful material composition in the redox flow cell when alkaline electrolytes are used.

The first layer is made of copper or nickel. This ensures good adhesion of the layer system to the metal substrate.

The non-metallic particles preferably comprise a proportion of electrically conductive particles, which bring about a significant reduction in the interface resistance on the component, and are in particular formed from at least one material from the group comprising carbon, graphite, carbon nanotubes, carbon fibers, soot, graphene, graphene oxide, metal nitride, metal carbide.

The proportion of electrically conductive particles is in particular more than 50% of the non-metallic particles. It has been shown that the electrically conductive particles that protrude from the second layer reliably maintain the electrical contact between the membrane of the electrochemical cell and the electrical contacts outside the electrochemical cell, even under highly corrosive conditions.

Particularly preferred is a combination of an alloy of a tin-nickel alloy comprising a nickel content in the range of 20 to 30 wt % with non-metallic particles dispersed therein made of at least one material from the group comprising carbon, graphite, carbon nanotubes, carbon fibers, soot, graphene, graphene oxide. This alloy forms an oxide layer on its surface as a passivation, which has a particular corrosion-inhibiting effect and increases the long-term stability of the electrochemical cell.

The non-metallic particles may further comprise a proportion of particles formed from a non-electrically conductive material, such as at least one material from the group comprising metal sulfide, metal oxide, diamond, mica, PTFE.

As the metal oxides, Al₂O₃, BeO₂, CdO, MgO, SiO₂, TiO₂, ZrO₂, Fe oxides, and the like are preferably used. SiC, WC, VC, TiC, Cr₂C₃, Cr₃C₂ and the like are preferably used as metal carbides. BN or SiN and the like are preferably used as metal nitrides. Carbon is particularly preferably used in the form of graphite, carbon nanotubes, carbon fibers, soot, graphene or also in the form of graphene oxide. MoS₂, MoS, NiFeS₂ and the like are preferably used as metal sulfides.

A preferred particle size of the non-metallic particles is in the range from 100 nm to 8 μm, in particular in the range from 500 nm to 6 μm. Particular preference is given to using particles in the nanometer range that can be particularly stably dispersed in an electrolyte for the electrodeposition of the second layer. In particular, the particle size is selected so that these protrude from the surface of the at least one second layer and thus ensure contact with a membrane.

A preferred volume fraction of non-metallic particles in the second layer is in the range from 2 to 50% by volume. This ensures reliable binding of the particles in the metallic matrix.

The metal substrate is preferably formed from a material from the group comprising stainless steel, such as the 1.4404 or DC04 grades, and furthermore titanium, a titanium alloy, aluminum, an aluminum alloy, an alloy predominantly containing tin. In this case, the first layer is preferably present to improve the adhesion of the layer system.

Alternatively, the metal substrate is formed from a material selected from the group consisting of copper, a copper alloy, nickel, a nickel alloy, a low-alloy carbon steel. In particular, the metal substrate is made of copper or nickel. In such a case, the first layer can also be omitted. 100Cr6 has proven itself as a low-alloy carbon steel.

The optional first layer and the at least one second layer are formed by electrodeposition. Using galvanic processes, the deposition of electrolyte leak-tight layers with a layer thickness >10 micrometers for use in PEM-EL and redox flow cells is easily possible. As a result, electrodeposited, conductive and durable layers can be achieved on metallic substrates such as stainless steel over a wide pH range and potential window. The non-metallic particles are dispersed in an electrolyte to form the second layer and are incorporated into the alloy deposited on the first layer to form the at least one second layer.

A single second layer or several second layers can be applied one on top of the other.

In particular, the electrodeposition is carried out using what is termed a “pulse plating” process, in which the voltage applied to the electrolyte is periodically switched off or reversed. Due to the short-term current surges received when switching on, an increasing number of nuclei are formed for metal deposition, thus creating a basis for fine-grained precipitates and luster.

The metal substrate is in particular in the form of a metal sheet or a metal foil with a thickness in the range of 0.05 to 1 mm. Furthermore, the metal sheet or the metal foil can have embossed three-dimensional structures to increase the surface area and thus increase the contact area with a fluid in an electrochemical cell.

The first layer preferably comprises a layer thickness of up to 5 μm, in particular in the range of up to 3 μm. The at least one second layer preferably has a layer thickness of up to 30 μm, in particular in the range from 5 to 20 μm. The preferred overall layer thickness of the layer system is <10 μm and is in particular in the range from 4 to 8 μm.

A surface of the second layer, which faces away from the metal substrate and forms the cover layer of the layer system, is in particular anodized. By means of such subsequent anodization, a targeted enrichment of the respective alloy element in the form of oxides is possible (surface modification). This is achieved by applying potentials to components immersed in aqueous electrolytes.

The component according to the disclosure is preferably designed in the form of an electrode for a redox flow cell, wherein the layer system covers the metal substrate of the redox flow cell at least in a contact region with an electrolyte, optionally further in a contact region with a graphite felt through which electrolyte flows.

The object is further achieved for a redox flow cell, in particular a redox flow battery, comprising the at least one electrode for the redox flow cell and at least one electrolyte, in particular with a pH in the range from −1 to 14.

The redox flow cell preferably comprises at least two electrodes, a first reaction chamber and a second reaction chamber, wherein each reaction chamber is in contact with one of the electrodes and wherein the reaction chambers are separated from each other by an ion exchange membrane. A graphite felt can be disposed in the reaction chambers, and adjacent to the respective electrode.

Thus, to form a redox flow battery, preferably more than 10, in particular more than 50 redox flow cells are used in an electrically interconnected manner.

The following anolyte is mentioned here as an example as suitable for a redox flow cell or a redox flow battery:
1.4 M 7,8-dihydroxyphenazine-2-sulfonic acid (short form: DHPS) dissolved in 1 molar caustic soda

The following catholyte is mentioned here by way of example as suitable for a redox flow cell or a redox flow battery:
0.31 M potassium hexacyanoferrate(II) and 0.31 M potassium
hexacyanoferrate(III) dissolved in 2 molar caustic soda.

Electrolyte combinations having aqueous electrolytes containing a redox-active organic species and/or metallic species on the anolyte side are preferably used to form a redox flow cell or a redox flow battery.

Another electrolyte (anolyte or catholyte) suitable for the redox flow cell is mentioned here by way of example:
1.6M VOSO₄ or V₂(SO₄)₃ dissolved in aqueous diluted sulfuric acid (pH<1).

The object is further achieved for a fuel cell, comprising at least one component according to the disclosure in the form of a flow field plate and at least one polymer electrolyte membrane.

Finally, the object is attained for an electrolyzer, comprising at least one component according to the disclosure in the form of a flow field plate or a fluid diffusion layer and at least one polymer electrolyte membrane. The electrolyzer is preferably set up for the electrolysis of water.

The following examples are intended to explain a component according to the disclosure:

### Example 1

Metal substrate: Stainless steel
electroplated first layer: Copper or nickel
electroplated second layer (DC, pulse plating):
Alloy: SnNi
non-metallic particles: graphite

### Example 2

Metal substrate: Titanium
electroplated first layer: Copper or nickel
electroplated second layer (DC, pulse plating):
Alloy: SnAg
non-metallic particles: titanium nitride and SiC

### Example 3

Metal substrate: Copper
electroplated first layer: not applicable
electroplated second layer (DC, pulse plating):
Alloy: SnCu
non-metallic particles: Graphite and SiC

### Example 4

Metal substrate: Aluminum
electroplated first layer: Copper or nickel
electroplated second layer (DC, pulse plating):
Alloy: SnZn
non-metallic particles: graphene oxide and SiO₂

### Example 5

Metal substrate: Stainless steel
electroplated first layer: Copper or nickel
electroplated second layer (DC, pulse plating):
Alloy: SnBi
non-metallic particles: Graphene and WC

### Example 6

Metal substrate: Titanium
electroplated first layer: Copper or nickel
electroplated second layer (DC, pulse plating):
Alloy: SnSb or SnMn
non-metallic particles: Soot and mica

### Example 7

Metal substrate: Stainless steel
electroplated first layer: Copper or nickel
electroplated second layer (DC, pulse plating):
Alloy: SnCo
non-metallic particles: Carbon nanotubes and MgO

### Example 8

Metal substrate: Stainless steel
electroplated first layer: Copper or nickel
electroplated second layer (DC, pulse plating):
Alloy: NiW
non-metallic particles: Graphite and MoS₂

### Example 9

Metal substrate: Stainless steel
electroplated first layer: Copper or nickel
electroplated second layer (DC, pulse plating):
Alloy: SnNi
non-metallic particles: Graphite and SiC

### BRIEF DESCRIPTION OF THE DRAWINGS

FIGS. 1 to 8 show examples of components and their use in electrochemical cells. In these:

FIG. 1 shows a component comprising a metal substrate and a layer system;

FIG. 2 shows the component according to FIG. 1 in a sectional view;

FIG. 3 shows a further component with three-dimensional structuring in a side view;

FIG. 4 shows a component having an integral metal substrate and first layer;

FIG. 5 shows a component in the form of an electrode with a three-dimensionally structured flow field;

FIG. 6 shows a redox flow cell or a redox flow battery having a redox flow cell,

FIG. 7 shows an electrolyzer in a sectional view, and

FIG. 8 shows a fuel cell stack in a three-dimensional view.

### DETAILED DESCRIPTION

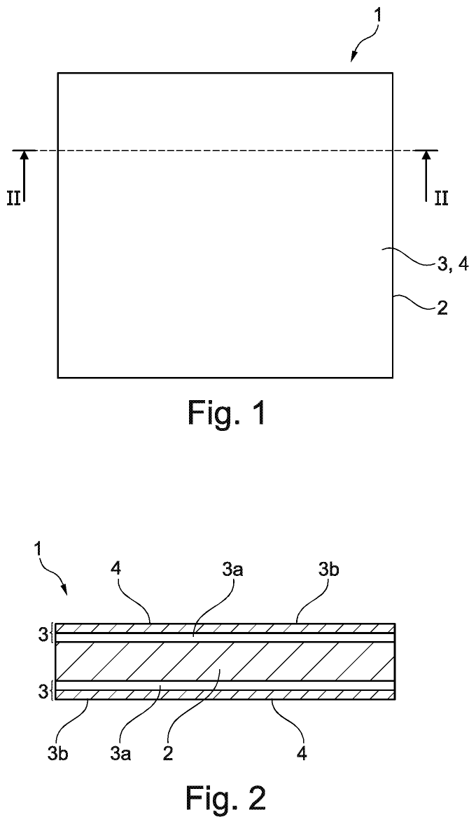

FIG. 1 shows a component 1 comprising a metal substrate 2 and a layer system 3 in a top view of a surface 4.

FIG. 2 shows the component 1 according to FIG. 1 in sectional view II-II. The same reference symbols as in FIG. 1 indicate identical elements. The metal substrate 2 can now be seen, for example, here made of stainless steel, in the form of a metal sheet. The metal sheet is electroplated on both sides with a first layer 3a made of nickel in a layer thickness of 1 μm. On the first layer 3 there is an electroplated second layer 3b made of a tin-nickel alloy containing non-metallic particles of graphite in a layer thickness in the range of 5 μm.

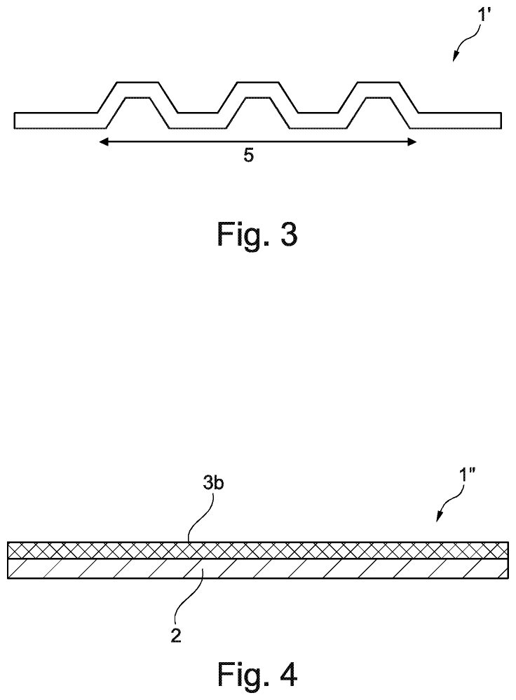

FIG. 3 shows another component 1′ with three-dimensional structuring 5 in a side view. The component 1′ comprises a metal substrate 2, not visible here, which is covered on all sides by a layer system 3.

FIG. 4 shows a component 1″ in cross-section, which has a metal substrate 2 made of nickel. Here at the same time, the metal substrate 2 forms the first layer 3a. The electroplated second layer 3b is made of a tin-nickel alloy containing non-metallic particles of graphite and SiC in a layer thickness of 10 μm.

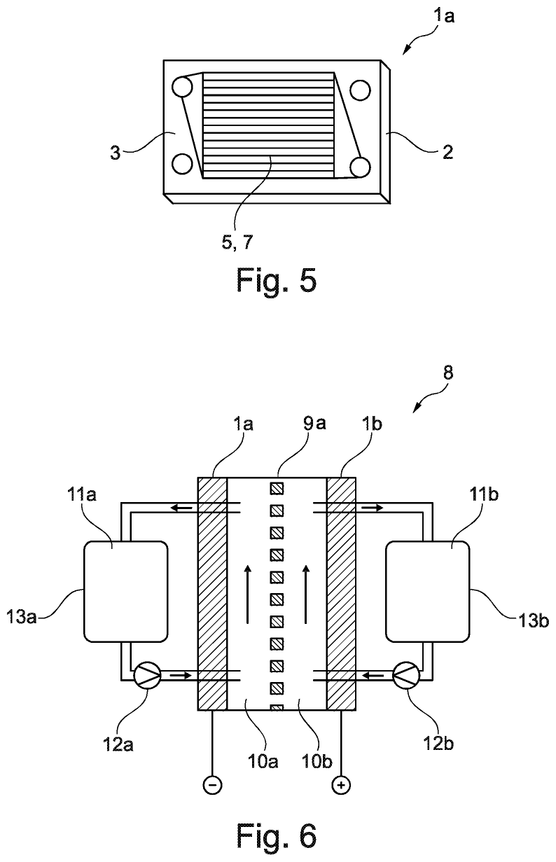

FIG. 5 shows a component 1a in the form of an electrode in a three-dimensional view, comprising a metal substrate 2 in the form of a metal sheet made of titanium coated with a layer system 3. In the metal substrate 2 there is a three-dimensional structuring 5 for forming a flow field 7 in each case, resulting in an increase in the surface area of the electrode onto which an electrolyte is caused to flow in a redox flow cell 8 (see FIG. 6).

FIG. 6 shows a redox flow cell 8 or a redox flow battery, respectively, having a redox flow cell 8. The redox flow cell 8 comprises two components 1a, 1b in the form of electrodes (see FIG. 5), a first reaction chamber 10a and a second reaction chamber 10b, wherein each reaction chamber 10a, 10b is in contact with one of the electrodes. Graphite felt, which is not shown separately here, can be disposed in the reaction chambers 10a, 10b. The flow fields 7 (see FIG. 5) of the electrodes, which are not visible here, are aligned facing an ion exchange membrane 9a and, if present, the respective graphite felt. The reaction chambers 10a, 10b are separated from one another by the ion exchange membrane 9a. The graphite felt, if present, is at least slightly compressed between the respective electrode and the ion exchange membrane 9a, wherein electrolyte liquid can flow through the graphite felt. The electrolyte can partially flow past the graphite felt in the region of a structured surface of the electrode and continue to flow through it. A liquid anolyte 11a is pumped from a tank 13a into the first reaction chamber 10a via a pump 12a and is fed through between the component 1a and the ion exchange membrane 9a. A liquid catholyte 11b is pumped from a tank 13b into the second reaction chamber 10b via a pump 12b and is fed through between the component 1b and the ion exchange membrane 9a. Ion exchange occurs across the ion exchange membrane 9a, wherein electrical energy is released due to the redox reaction at the electrodes.

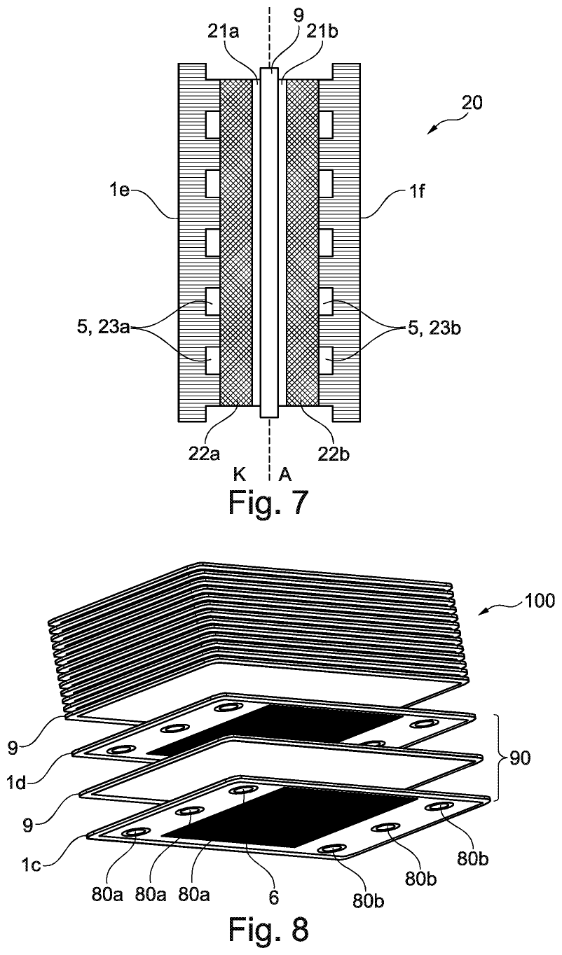

FIG. 7 shows an electrolysis cell 20 of an electrolyzer comprising a polymer electrolyte membrane 9 which separates an anode side A and a cathode side K from one another. A catalyst layer 21a, 21b, each comprising a catalyst material and a fluid diffusion layer 22a, 22b made of titanium (anode-side) and a graphite felt (cathode-side), is disposed adjacent to the catalyst layer 21a, 21b on both sides of the polymer electrolyte membrane 9. The fluid diffusion layers 22a, 22b are each disposed adjacent to a component 1e, 1f in the form of an electrically conductive plate. The plates are made of stainless steel and have an electroplated layer system 3 (see FIG. 2) at least on the sides thereof facing the fluid diffusion layers 22a, 22b. Furthermore, the plates each have a three-dimensional structuring 5, which forms flow channels 23a, 23b on the sides of the plates facing the fluid diffusion layers 22a, 22b, respectively, to improve the supply of reaction medium (water) and the removal of reaction products (water, hydrogen, oxygen).

FIG. 8 schematically shows a fuel cell stack 100 comprising multiple fuel cells 90. Each fuel cell 90 comprises a polymer electrolyte membrane 9 adjacent to both sides of components 1c, 1d in the form of flow field plates. Each flow field plate has a metal substrate 2 having an electroplated layer system 3 (see FIG. 2). The flow field plate has an inflow region with openings 80a and an outlet region with further openings 80b, which are used to supply a fuel cell 90 with process gases and coolant and to remove reaction products from the fuel cell 90 and coolant. The flow field plate also has a gas distribution structure 6 on each side, which is provided for contact with the polymer electrolyte membrane 9.

FIGS. 1 to 8 are intended to explain the disclosure only by way of example. However, the inventive concept should further comprise electrochemical cells having at least one component designed according to the disclosure.

### LIST OF REFERENCE SYMBOLS

1, 1′, 1″, 1a, 1b, 1c, 1d, 1e, 1f Component
2 Metal substrate
3 Layer system
3a First layer
3b Second layer
4 Surface
5 Three-dimensional structuring
6 Gas distribution structure
7 Flux field
8 Redox flow cell
9 Polymer electrolyte membrane
9a Ion exchange membrane
10a First reaction chamber
10b Second reaction chamber
11a Anolyte
11b Catholyte
12a, 12b Pump
13a, 13b Tank
20 Electrolytic cell
21a, 21b Catalyst layer
22a, 22b Fluid diffusion layer
23a, 23b Flow channels
80a, 80b Openings
90 Fuel cell
100 Fuel cell stack
A Anode side
K Cathode side

1. A component of an electrochemical cell, the component comprising:
a metal substrate,
a layer system which is at least partially electroplated onto the metal substrate, the layer system comprising a first layer disposed on the metal substrate, and at least one second layer disposed on the metal substrate, the first layer being formed from copper or nickel and the at least one second layer being formed from an alloy comprising at least two of the elements tin, copper, nickel, silver, zinc, bismuth, antimony, cobalt, manganese, or tungsten, with non-metallic particles comprising electrically conductive particles embedded in the alloy.

2. The component according to claim 1, wherein the alloy is formed from a tin-nickel alloy with a nickel content in a range of 20 to 30 wt %.

3. The component according to claim 1, wherein the alloy is formed from a copper-tin alloy or a tin-silver alloy or a tin-zinc alloy or a tin-bismuth alloy or a tin-antimony alloy or a tin-cobalt alloy or a nickel-tungsten alloy or a tin-manganese alloy.

4. The component according to claim 1, wherein the non-metallic particles comprise a proportion of the electrically conductive particles which are formed from at least one material from the group comprising carbon, graphite, carbon nanotubes, carbon fibers, soot, graphene, graphene oxide, metal nitride, or metal carbide.

5. The component according to claim 4, wherein the non-metallic particles further comprise a proportion of particles formed from at least one material from the group comprising metal sulfide, diamond, metal oxide, mica, or PTFE.

6. The component according to claim 1, wherein the metal substrate is formed from a material from the group comprising stainless steel, titanium, a titanium alloy, aluminum, an aluminum alloy, or an alloy predominantly containing tin.

7. The component according to claim 16, wherein the metal substrate is formed from a material from the group comprising copper, a copper alloy, nickel, a nickel alloy, or low-alloy carbon steel.

8. The component according to claim 1, wherein the first layer has a layer thickness of up to 5 μm.

9. The component according to claim 1, wherein the at least one second layer has a layer thickness of up to 30 μm.

10. The component according to claim 1, wherein a surface of the at least one second layer facing away from the metal substrate is anodized.

11. An electrode comprising the component according to claim 1, wherein the electrode is adapted for a redox flow cell, and the layer system covers the metal substrate at least in a contact region with an electrolyte of the redox flow cell.

12. A redox flow cell, comprising at least one of the electrodes according to claim 11 and at least one electrolyte.

13. The redox flow cell according to claim 12, wherein the at least one of the electrodes comprises at least two of the electrodes, and further comprising a first reaction chamber and a second reaction chamber, wherein each of the first and second reaction chambers is in contact with one of the electrodes and the first and second reaction chambers are separated from each other by an ion exchange membrane.

14. A fuel cell comprising at least one of the components according to claim 1 which comprises a flow field plate, and at least one polymer electrolyte membrane.

15. An electrolyzer, comprising at least one of the components according to claim 1 which comprises a flow field plate or a fluid diffusion layer, and at least one polymer electrolyte membrane.

16. A component of an electrochemical cell, the component comprising:
a metal substrate,
a layer system which is at least partially electroplated onto the metal substrate, the layer system comprising at least one second layer disposed on the metal substrate, the at least one second layer being formed from an alloy comprising at least two of the elements tin, copper, nickel, silver, zinc, bismuth, antimony, cobalt, manganese, or tungsten, with non-metallic particles comprising electrically conductive particles embedded in the alloy.

17. The component according to claim 16, wherein the alloy is formed from a tin-nickel alloy with a nickel content in a range of 20 to 30 wt %.

18. The component according to claim 16, wherein the alloy is formed from a copper-tin alloy or a tin-silver alloy or a tin-zinc alloy or a tin-bismuth alloy or a tin-antimony alloy or a tin-cobalt alloy or a nickel-tungsten alloy or a tin-manganese alloy.

19. The component according to claim 16, wherein the non-metallic particles comprise a proportion of the electrically conductive particles which are formed from at least one material from the group comprising carbon, graphite, carbon nanotubes, carbon fibers, soot, graphene, graphene oxide, metal nitride, or metal carbide.

20. The component according to claim 16, wherein a surface of the at least one second layer facing away from the metal substrate is anodized.
